(19) United States
(12) Patent Application Publication
(10) Pub. No.: US 2003/0035623 A1
(43) Pub. Date: Feb. 20, 2003

(54) Method and apparatus for producing fiber bragg grating using a telescope

(76) Inventors: Russell Wilcox, El Cerrito, CA (US); Scott Fochs, Livermore, CA (US)

Correspondence Address: DALLAS OFFICE OF FULBRIGHT & JAWORSKI L.L.P., 2200 ROSS AVENUE, SUITE 2800, DALLAS, TX, 75201-2784, US

(21) Appl. No.: 09/929,878

(22) Filed: Aug. 14, 2001

(51) Int. Cl. G02B 6/34; G02B 5/18; G02B 23/00; G02B 27/44; G02F 1/03

(52) U.S. Cl. 385/37; 359/399; 359/566; 359/245

(57) ABSTRACT

The invention writes a fiber Bragg grating (FBG) onto a fiber. The invention uses a phase mask to separate an input beam into two beams, and possibly encode each of the two beams with phase information. The invention then uses one or more modulators to possibly encode phase information onto the two beams. An image relay telescope collects the two beams and causes the two beams to interfere with each other to form the FBG on the fiber according to the phase information encoded on the two beams. The image that is incident onto the input surface of the telescope is re-imaged at the output surface of the telescope. Thus, either the phase mask or the modulators, or a combination of both can encode phase information onto the two beams.

### BACKGROUND OF THE INVENTION

The present invention relates in general to fiber Bragg gratings, and in specific to method and apparatus for producing fiber Bragg gratings using imaging optics and electronic phase control.

Normal optical fibers are uniform along their lengths. A slice from any one point of the fiber looks like a slice taken from anywhere else on the fiber, disregarding tiny imperfections. However, it is possible to make fibers in which the refractive index varies regularly along their length. These fibers are called fiber gratings because they interact with light like diffraction gratings. Their effects on light passing through them depend very strongly on the wavelength of the light.

A diffraction grating is a row of fine parallel lines, usually on a reflective surface. Light waves bounce off of the lines at an angle that depends on their wavelength, so light reflected from a diffraction grating spreads out in a spectrum. In fiber gratings, the lines are not grooves etched on the surface, instead they are variations in the refractive index of the fiber material. The variations scatter light by what is called the Bragg effect, hence fiber Bragg gratings (FBGs). Bragg effect scattering is not exactly the same as diffraction scattering, but the overall effect is similar. Bragg scattering reflects certain wavelengths of light that resonate within the grating spacing while transmitting other light.

FBGs are used to compensate for chromatic dispersion in an optical fiber. Dispersion is the spreading out of light pulses as they travel on the fiber. Dispersion occurs because the speed of light through the fiber depends on its wavelength, polarization, and propagation mode. The differences are slight, but accumulate with distance. Thus, the longer the fiber, the more dispersion. Dispersion can limit the distance a signal can travel through the optical fiber because dispersion cumulatively blurs the signal. After a certain point, the signal has become so blurred that it is unintelligible. The FBGs compensate for chromatic (wavelength) dispersion by serving as a selective delay line. The FBG delays the wavelengths that travel fastest through the fiber until the slower wavelengths catch up. The spacing of the grating is linearly chirped, increasing along its length, so that different wavelengths are reflected at different points along the fiber. These points correspond to the amount of delay that the particular wavelengths need to have so that dispersion is compensated. Suppose that fiber induces dispersion such that a longer wavelength travels faster than a shorter wavelength. Thus, a longer wavelength would have to travel farther into the FBG before being reflected back. A shorter wavelength would travel less far into the FBG. Consequently, the longer and shorter wavelengths can be made coincidental, and thus without dispersion. FBGs are discussed further in Feng et al. U.S. Pat. No. 5,982,963, which is hereby incorporated herein by reference in its entirety.

FBGs are typically fabricated in two manners. The first manner uses a phase mask. The phase mask is quartz slab that is patterned with a grating. The mask is placed in close proximity with the fiber, and ultraviolet light, usually from an ultraviolet laser, is shined through the mask and onto the fiber. As the light passes through the mask, the light is primarily diffracted into two directions, which then forms an interference pattern on the fiber. The interference pattern comprises regions of high and low intensity light. The high intensity light causes a change in the index of refraction of that region of the fiber. Since the regions of high and low intensity light are alternating, a FBG is formed in the fiber. See also Kashyap, “Fiber Bragg Gratings”, Academic Press (1999), ISBN 0-12-400560-8, which is hereby incorporated herein by reference in its entirety.

The second manner is known as the direct write FBG formation. In this manner two ultraviolet beams are impinged onto the fiber, in such a manner that they interfere with each other and form an interference pattern on the fiber. At this point, the FBG is formed in the same way as the phase mask manner. One of the fiber and the writing system is moved with respect to the other such that FBG is scanned or written into the fiber. Note that the two beams are typically formed from a single source beam by passing the beam through a beam separator, e.g. a beamsplitter or a grating. Also, the two beams are typically controlled in some manner so as to allow control over the locations of the high and low intensity regions. For example, Laming et al., WO 99/22256, which is hereby incorporated herein by reference in its entirety, teaches that beam separator and part of the focusing system is moveable to alter the angle of convergence of the beams, which in turn alters the fringe pitch on the fiber. Another is example is provided by Stepanov et al., WO 99/63371, which is hereby incorporated herein by reference in its entirety, and teaches the use of an electro-optic module, which operates on the beams to impart a phase delay between the beams, which in turn controls the positions of the high and low intensity regions.

Each manner has advantages and disadvantages when compared with each other. For example, the first manner, the phase mask manner, is relatively inflexible, as changes cannot be made to the mask. However, since the phase mask is permanent, the phase mask manner is stable, repeatable, and aside from the cost of the mask, relatively inexpensive to operate. On the other hand, the direct write manner is very flexible, and can write different gratings. However, this manner is less repeatable and is costly to operate.

### BRIEF SUMMARY OF THE INVENTION

These and other objects, features, and technical advantages are achieved by a system and method system for making fiber Bragg gratings using either phase mask writing or direct writing, or a combination of both. The invention preferably uses a phase mask to separate an input beam into two beams, and possibly encode each of the two beams with phase information. The invention also preferably uses one or more modulators to possibly encode phase information onto the two beams. The invention further preferably uses an image relay telescope to remove the effects of diffraction from the phase mask that result from physical separation of the mask and the fiber. The relay telescope preferably collects the two beams and causes the two beams to interfere with each other to form the FBG in the core of the fiber according to the phase information encoded on the two beams. Thus, either the phase mask or the modulators, or a combination of both can encode phase information onto the two beams.

A preferred embodiment of the invention has the relay telescope have a magnification of 1:1. Thus, whatever image is incident onto the input surface of the telescope is the same image that exits the output surface of the telescope.

Another embodiment of the invention is that the phase mask and the fiber are attached to a first fixture, while the telescope, modulators, and laser projecting optics are attached to a second fixture. One of the fixtures would be moved with respect to the other fixture to allow the FBG to be scanned onto the fiber. Alternatively, both fixtures could be moved.

Therefore, it is a technical advantage of the invention to allow phase information to be imposed onto the write beams by either a phase mask or modulators or a combination of both.

It is another advantage of the invention to separate the phase mask from the fiber, and re-image the phase mask onto the fiber.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 depicts a direct write embodiment of the present invention;

FIG. 2 depicts a portion of re-imaging telescope of FIG. 1;

FIG. 3 depicts a graph showing the relationship between the cell voltage and the interference pattern of the invention of FIG. 1;

FIG. 4 depicts different embodiment of the invention of FIG. 2 using acousto-optic cells;

FIGS. 5A and 5B depict views of an embodiment of the invention using a corner reflector;

FIGS. 6A and 6B depict views of an embodiment of the invention using a Porro prism;

FIGS. 7A and 7B depict views of an embodiment of the invention using a roof prism;

FIG. 8 depicts a view of an embodiment of the invention using a mirror; and

FIG. 9 depicts views of different embodiments of the two telescope arrangement shown in FIG. 1.

### DETAILED DESCRIPTION OF THE INVENTION

FIG. 1 depicts a scanning fiber grating exposure system based on this invention. This system preferably performs scanning by moving fiber 109 and mask 105, while leaving the incident laser beam and the re-imaging telescope 100, 901 stationary. This preferred embodiment minimizes the amount of equipment which moves. Alternatively, the fiber 109 and the mask 105 may remain fixed, while moving the telescope 100, 901 and laser beam, in order to minimize vibration of the fiber 109 with respect to the mask 105.

Motor 302 is used to move fixture 303 upon which fiber 109 is supported. An interferometer 304 detects the precise position of fixture 303, and provides this information to computer (or other controller) 305. Note that a different type of encoder can be used to provide this information to the computer. Computer 305 sends movement commands to motor 302, and voltage signals to modulators 103, 104. Thus, the phase control of the modulators can be synchronized with the stage movement to allow for precise writing of the FBG. The mask 105 is also connected to the fixture 303, thus any movement of the fixture 303 (and the fiber 109) would also cause the mask 105 to move. Alternatively, the mask 105 may be moved via a separate motor, and include an encoder to an encoder to feedback position information of mask 105 to computer 305.

This invention is preferably used in a scanning exposure system, although a stationary exposure system using the invention could be constructed, and would benefit from these innovations. In the case of a scanning system, the fiber may move with respect to the telescope, mask, and input laser beam (in which case the mask is used primarily as a beamsplitter), or both the fiber and mask may move with respect to the telescope and laser beam (in which case the mask is used to impart information onto the fiber). In the embodiment where the fiber and mask are moving with respect to the telescope, they may move at the same velocity or at different velocities. In the preferred embodiment, they move together on the same fixture, as this is simplest in terms of requiring the fewest moving components.

The simplest type of image relay telescope consists of two lenses separated by the sum of their focal lengths (f1+f2). The image magnification of this telescope is −1, indicating that the output plane image is inverted with respect to the input plane. In the case of the preferred embodiment of a scanning system described in FIG. 1, this image inversion requires a more complex optical arrangement, with optics included to re-invert the image so the net magnification is 1 rather than −1. The embodiment of FIG. 1 depicts a second telescope 901 being used as the re-imaging optics to produce a proper image. Note that other optics and/or optical arrangements could be used. This allows the image of the mask to move at the same velocity as the fiber. The image inversion problem could also be solved by requiring the modulators inside the telescope to correct for a velocity inversion, but it precludes operation where the modulators act on the beam slightly or not at all. Such operations may have utility when no information is to be imparted by the modulators, or no modulators are used, or when slower modulators are used, for instance to impart a gradual phase variation along the fiber grating.

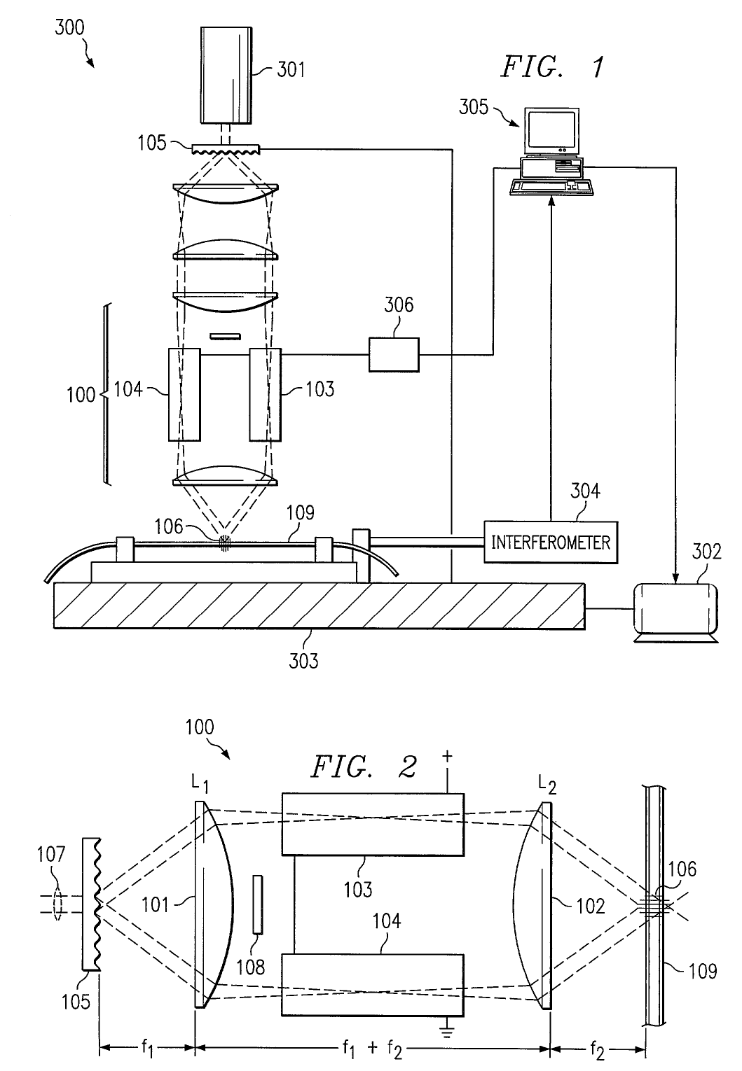

FIG. 2 depicts the inventive re-imaging telescope 100, which comprises two lenses, L1 101 and L2 102, and two modulators 103 and 104. Note that the re-imaging optics are not shown for the sake of simplicity. A source beam 107 is incident onto beamsplitter 105, which is preferably a phase mask or diffraction grating. Note that other beamsplitters may be used, so long as the source beam is separated into two beams. If a phase mask or diffraction grating is used, then such mask or grating should be arranged such that most of the source beam is moved into the first orders. Lens L1 101 would be arranged to receive only the zero and first order beams. A stop 108 could be used to block any zero order beam. Note that stop 108 may be placed anywhere between the grating 105 and the fiber 109, but must be positioned to block the zero order. If there are special features or information in grating 105, such as phase shifts, then this information is imparted to the beams as well.

After source beam 107 has been divided, the two beams impinge on lens L1 101. This lens is designed to capture the two beams and to form an intermediate image within the telescope 100. Each beam then impinges on a respective modulator 103, 104.

The modulators, or phase shifters, control the relative delay (phase) between the two beams, and thereby control the locations of the high and low intensity regions of the interference pattern 106. The modulator are preferably electro-optic modulators, but may be mechanically driven devices such as wedge, waveplate, grating, or a phase mask. The modulator may also comprise thermo-optic, acousto-optic, or magneto-optic devices. A preferred type of electro-optic modulator is a Pockels cell, which comprises an electro-optic crystal that changes its refractive index when a voltage is applied to the crystal. The change in the index advances or retards the light beam with respect to the other beam. The two modulators 103, 104 are preferably changed together, such that a desired delay is expressed as a advance in one beam and a retard in the other beam. This eliminates making one large change to one beam. The voltages applied to the modulators are preferably controlled by a computer to allow precise placement of the high and low regions. The computer preferably sends control signals to a high voltage driver or amplifier 306, which boosts the signals from the computer to voltages usable by the modulators 103, 104.

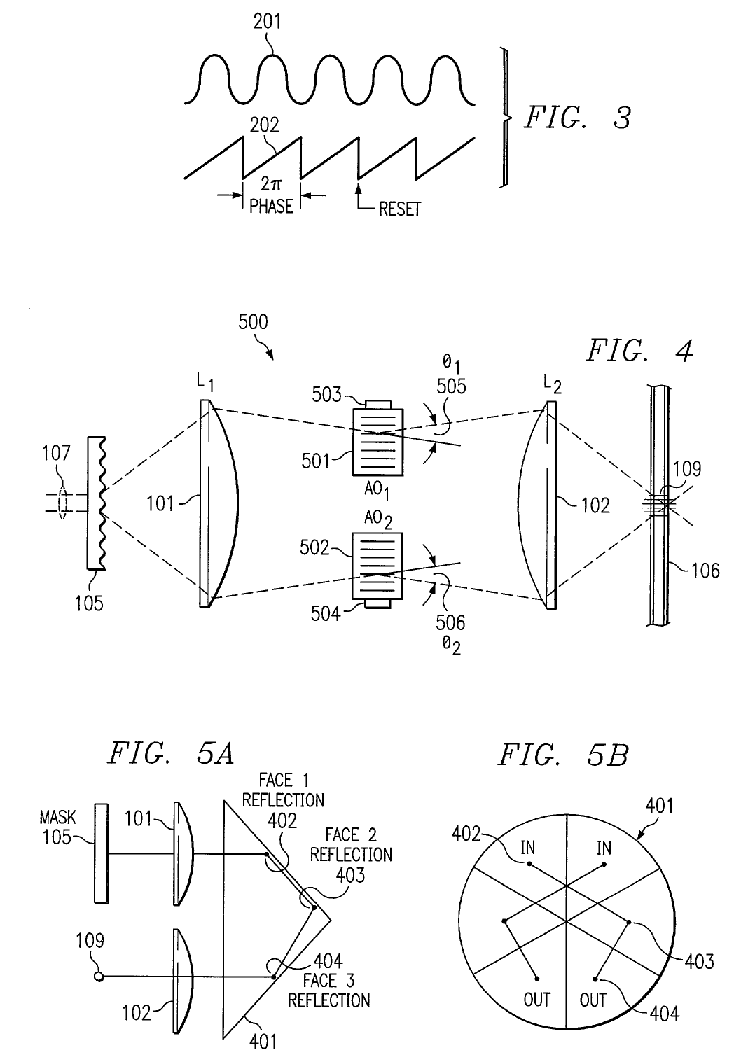

FIG. 3 depicts the relationship between the cell voltage 202 and the interference pattern 201 (106 of FIG. 1). Interference pattern 201 is that of a point at the intersection of the two beams, where the point is stationary with respect to the beams and the telescope, but is moving with respect to the fiber. As shown, the interference pattern 201 is sinusoidal. As the voltage is varied, the sinusoidal pattern shifts horizontally in phase along the fiber. The interference pattern should move continuously to track fiber motion. This occurs when the applied voltage, V=2nVπ, where n is the number of fringe periods traveled by the fiber, and Vπ is the voltage required by the cell to achieve a π phase shift. This results in too high of a voltage, therefore the cells are reset to zero after every 2π relative phase shift. Resetting is relatively fast, so there are negligible side effects. Note that the modulators can be controlled independently of each other, e.g. with each having different voltages applied thereto. Further note that the modulators are shown to be located at the focal point inside the telescope, however they may be located elsewhere on the optical path inside the telescope.

FIG. 4 depicts an example of the invention of FIG. 2 using acousto-optic modulators 501, 502. Again, the re-imaging optics are not shown for the sake of simplicity. Modulators 501, 502 are arranged so that the in deflection angles θ₁ 505 and θ₂ 506 are equal. Inputs 503, 504 provide the frequencies to the modulators. The acoustic frequencies are chosen to be slightly different so as to impart a continuous relative phase change to the beams. This arrangement does not have to be reset, as with the Pockels cells.

After modulation, the beams impinge on the second lens L2 102. This lens is designed to capture the two beams and to focus them onto the fiber 109, such that the beams interfere with each other and form the desired interference pattern 106 on the fiber 109.

The lenses L1 101 and L2 102 preferably have similar lens characteristics, e.g. the same focal length, f1=f2=f. Preferably locating the lens 2f from each other would form a relay telescope or re-imaging telescope. Note that this means that the telescope has a 1:1 magnification, but other magnifications could be used. Relay telescopes take the Fourier transform of the input plane information twice, and relay it to the output plane. Thus, the amplitude and phase information at the input plane are reproduced in the output plane. This provides a greater depth of field than a simple, one lens imaging system.

Moreover, as long as the mask 105 and fiber 109 are 4f (four focal lengths) apart, the telescope could be located any where between the mask 105 and the fiber 109, and still re-image the mask onto the fiber. This feature is preserved when additional optics are introduced to erect the image, as will be described later, and has advantages when the system is scanning. Consider, for example, a system wherein the mask 105 and fiber 109 are held rigidly on one fixture, while the telescope and laser beam projecting optics are rigidly held together on another fixture. One (or both) of these fixtures could be moved with respect to the other to scan the exposing beam across the fiber, and their respective position does not have to be precisely controlled in the beam propagation direction due to this aspect of the relay telescope.

The lenses L1 101 and L2 102 are depicted as single element, plano convex, spherical lenses. However, other lenses, e.g., double convex or positive meniscus lenses, may be used. In additional, multiple element lenses may be used, e.g., doublets or triplets. The lenses may be cylindrical lenses as separation is occurring only in one plane. Moreover, each of L1 and L2 lenses may comprise lens systems with multiple lenses that have one or more air gaps between them. Furthermore, each of the L1 and L2 lenses may be moveable to perform macro, zooming, or focusing operations. One example of lenses L1 and L2 is as follows, from input to output, where R is the radius of curvature in millimeters, T is the thickness in millimeters, the refractive index for air is 1, and the refractive index for the glass is 1.45 (UV grade), and R-1-R6 is lens L1 and R7-12 is lens L2:

R1=infinity

T1=2.71 (glass)

R2=45.7

T2=4.32 (air)

R3=infinity

T3=6.93 (glass)

R4=20.57

T4=1.173 (air)

R5=infinity

T5=4.34 (glass)

R6=47.99

T6=69.8 (air)

R7=47.99

T7=4.34 (glass)

R8=infinity

T8=1.173 (air)

R9=20.57

T9=6.93 (glass)

R10=infinity

T10=4.32 (air)

R11=45.7

T11=2.71 (glass)

R12=infinity

FIG. 2 depicts lens L1 101 receiving both beams. However, an alternative embodiment would replace the single lens with two smaller lenses, each having similar properties. Each would be positioned to receive a respective beam. Similarly, lens L2 102 could also be replaced with two smaller lenses.

Note that by having some information stored on mask 105, and adding other information to the writing beams by the modulators 103, 104, the embodiment of the invention using modulators combines the advantages of both the phase mask manner and the direct write manner. A user may find that certain combinations of mask-stored fringe information and electronically controlled fringe information are advantageous for writing certain kinds of gratings. This invention provides for control over the FBG period by using a mask to provide some information, while the phase shifters provide other information. Complex features such as phase shifts, can be added by the modulators or put into the mask, or combinations of both, depending on which technique is best.

An example of the use of the system would be to have a mask with all the FBG grating information encoded in it, except for the apodization profile. The modulators could be modulated at a high frequency out of sync with the stage movement at points where the fringe visibility was desired to be low, in order to vary the modulation index in the fiber while maintaining the average index. By varying the amplitude of modulation of the modulators, the fringe visibility can be controlled.

Another example is for a chirped grating. If the mask used is of uniform period, and the grating is scanned in exposure, the modulators can be slowly varied in phase so that they add small amounts of phase to the FBG period as the FBG is being written. This will slowly vary the average period and chirp the grating. Such a slow phase addition could be performed by a thermo-optic modulator.

Note that the modulators themselves can also handle multiple information signals. The above example of apodizing can be performed by superimposing the signal for apodization on the signal for phase shifting. Further note that if the system is to be used only for direct writes, the mask can be stationary or can be replaced with any other type of beam splitter, and the information about the FBG fringes can be imparted only by the modulators. If the system is to be used for phase mask writing, then no voltage is supplied to the modulators (or no modulators are used) and the desired grating (or information) is stored on the mask 105, and the mask and fiber are moved together to scan the information onto the fiber. Note that some voltage could be applied to one or both modulators to equalize the path length between the two beams.

In another embodiment, a desired grating has a non-uniform period where the there are regions of uniform period with rapid phase shifting between the uniform regions. Thus, as the fiber is being scanned, the modulator could be used to rapidly shift the fringe pattern on the fiber by rapidly changing the phase between the two modulators. Thus, a grating is formed that has multiple uniform regions are separated by a phase shift. This type of grating is useful for making distributed feedback (DFB) lasers or for making multi-channel fiber gratings.

Note that the phase mask may also encode amplitude information onto the writing beams. Moreover, one or more of the modulators may also encode amplitude information onto the writing beams. Furthermore, the combination of the phase mask and one or more modulators may also encode amplitude information onto the writing beams. Alternatively, additional filter(s), modulator(s), and/or mask(s) may be used to encode amplitude information or other information as needed.

Note that the image relay telescope of FIG. 2 actually has a magnification of −1. That is, the image is reproduced at the output plane but with an inversion of both axes, so that any image or motion will be reversed and flipped. While this acceptable for a stationary imaging system, this arrangement will not work for a scanning imaging system. In order to scan, the fringe image must be stationary with respect to the fiber. If the image of the mask interference pattern is scanned through a simple telescope, the image on the fiber will move in the opposite direction, causing a smearing of the image and no net exposure pattern. In order to rectify this problem, additional optics must be used to reorient the image. For example, with terrestrial refracting telescope or binoculars, a pair of positive lenses is used for light gathering and focusing, but prisms and/or mirrors are used to erect the image for viewing. In these cases, optics are placed inside the binoculars, between the lenses, or outside the telescope near the eyepiece. The image erecting optics for the invention can comprise of prisms, mirrors, and/or an additional telescope to reorient the image.

The corner cube 401 of FIG. 5A can be used to erect the image. In general, erecting optics will have the beams to cross each other an odd number of times as viewed from the beam direction (with the additional crossing of the imaging telescope forms a total of an even number of crossings), and/or there will have an odd number of reflections of each beam (again when totaled with the imaging telescope causes an even number of events). As shown in FIG. 5A, the two beams enter the corner cube 401, incur three reflections, 402, 403, 404, and exit the corner cube. Preferably, the input laser beam, lenses and corner cube are on one fixture, while the mask and fiber are on another, and these two fixtures move with respect to one another to scan the fringe image onto the fiber. FIG. 5B depicts the beam paths in the corner cube 401, as seen from the direction of the input beams. Note that the corner cube plus the telescope provide a correct image and do not have image reversal, thus the mask and the fiber can then be moved together in a scanning system. The focal point would preferably occur in the center of the corner cube in the optical path.

Note that the advantage of this scheme is that it is compact and allows the mask and fiber to be rigidly mounted next to each other for stability. If modulators are to be used with this arrangement, then they would have to be small and/or integrated with the corner cube. For example, having the corner cube be the substrate for an acousto-optic modulator.

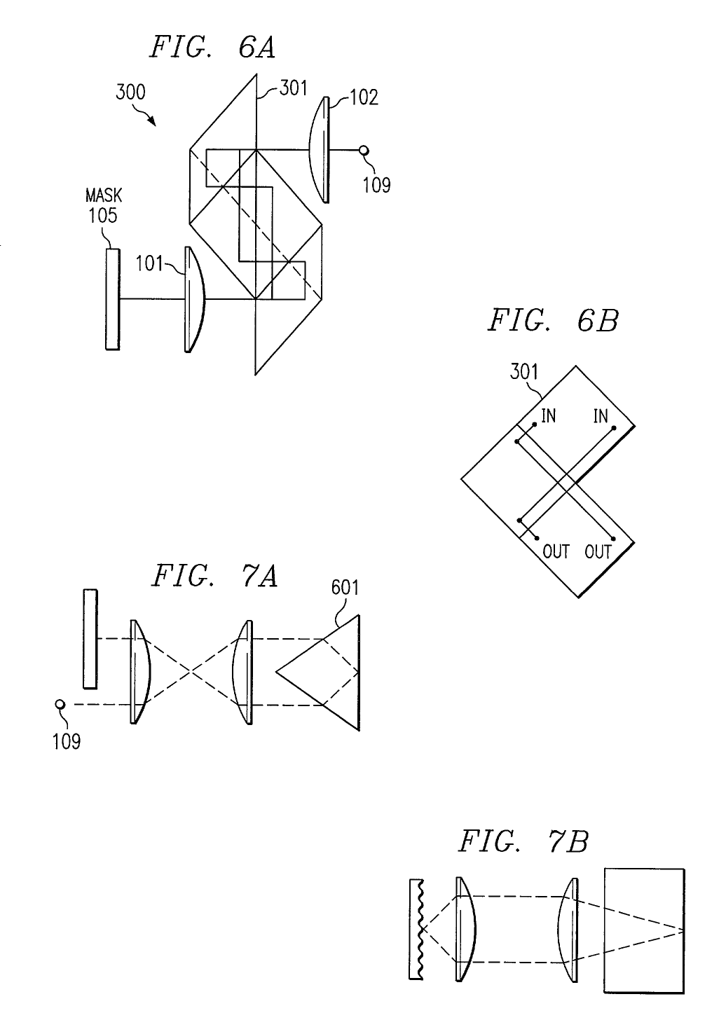

FIG. 6A depict an alternative arrangement for the inventive telescope and erecting optics, specifically the erecting optics is a Porro prism 701. Such prisms are commonly used in binoculars. Note that the output beams are displaced with respect to the input beams. FIG. 6B depicts the beams paths in the prism 701, as seen from the direction of the input beams. The two long paths in this figure are in different planes, which would allow for modulators to be placed in the optical paths, e.g. Pockels cell phase modulators. Moreover, the prism itself could be formed from electro-optic material, and with appropriate electrodes applied, serve as a modulator in addition to being the image erector.

Other types of prisms may be used, for example, FIG. 7A depicts a roof prism 601, which reflects the beams back through the telescope. FIG. 7B depicts a side view of the arrangement of FIG. 7A. The prism 601 allows for one reflection while displacing the beam vertically, separating the fiber and mask. Use of a prism in this case instead of a mirror has the additional advantage of using total internal reflection in a robust dielectric substrate, making optical damage less likely, e.g. destruction of the optical coatings by high intensity UV light. Other prism types could be used, for example a Dove prism.

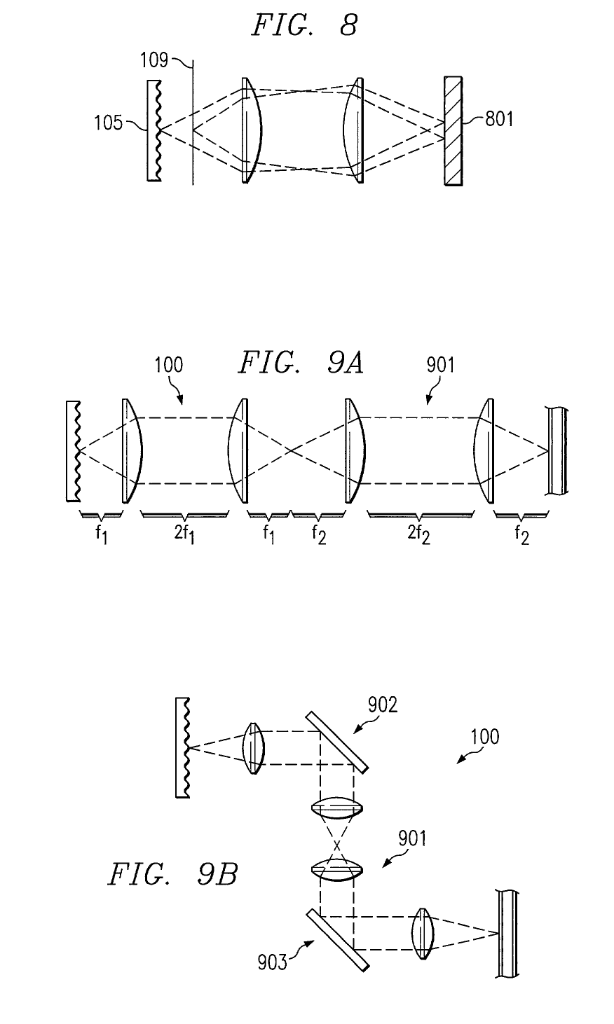

If damage is not an issue, the arrangement of FIG. 8 could be used wherein a mirror 801 simply reflects the beams back through the telescope. Since the beams effectively pass through two telescopes, an erect image is produced. In order to separate the fiber and mask, and to remove the mirror from the focal plane, the mirror may preferably be displaced some distance from the focal plane and preferably be tilted in a direction perpendicular to FIG. 8. Tilting can be performed, for example, by using an adjustable mirror mount. Since the beams nearly retrace each others paths, phase modulation in this scheme is difficult, unless a non-reciprocal modulator is used, such as a Faraday rotator, or a highly angle sensitive modulator is used, such as an acousto-optic modulator.

Another arrangement uses a second telescope 901 that is placed after the first telescope 100, as shown in FIG. 9A. The second telescope performs the same reversing operation as the first telescope, thus correcting the image reversal. An advantage of this scheme is that there is space for the introduction of phase modulators in the parallel beams between lenses. Note that the second telescope does not have to be identical to the first telescope, as a smaller (or larger) telescope may be used. Preferably, to reduce the size of the structure and improve stability, the one telescope (e.g. the second telescope 901) is smaller than the other telescope. This would allow modulator to be placed in the larger telescope (e.g. the first telescope 100), and the second telescope can perform the image erecting. Note that additional optics can be added to the arrangement, as only the requirement is that the image (in amplitude and phase) appear at the output plane in the correct orientation. For example, as shown in FIG. 9B, mirrors 902, 903 may be added to fold the beam path and make the system more compact.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An optical device comprising:
a beam separator that receives an input beam and separates the input beam into two beams;
at least one modulator that receives at least one beam of the two beams; and
a telescope that receives the two beams and provides an image of the two beams to an output plane;
wherein at least one of the beam separator and the modulator encodes phase information onto the two beams.

2. The optical device of claim 1 wherein the beam separator encodes phase information and the one modulator encodes phase information.

3. The optical device of claim 1 wherein the input beam is an ultraviolet input beam.

4. The optical device of claim 1 wherein the beam separator is a phase mask.

5. The optical device of claim 4 wherein the phase mask forms the two beams by diffracting the input beam into two first order beams.

6. The optical device of claim 5 wherein the device further comprises:
a stop which blocks a zero order diffracted beam.

7. The optical device of claim 1 wherein the beam separator is a beam splitter.

8. The optical device of claim 7 wherein the beam splitter does not encode phase information onto either beam of the two beams.

9. The optical device of claim 1 wherein the one modulator is selected from the group consisting of:
electro-optic, mechanically driven, thermo-optic, acousto-optic, and magneto-optic.

10. The optical device of claim 1 wherein the one modulator is an electro-optic modulator.

11. The optical device of claim 10 wherein the electro-optic modulator is a Pockels cell modulator.

12. The optical device of claim 10 wherein the one modulator does not encode phase information onto either beam of the two beams.

13. The optical device of claim 1 wherein the two beams interfere with each other at an output plane to form an interference pattern.

14. The optical device of claim 13 wherein the interference pattern is formed proximate to an optical fiber.

15. The optical device of claim 13 wherein the interference pattern forms a grating in the optical fiber.

16. The optical device of claim 15 wherein the grating is Bragg grating.

17. The optical device of claim 14 further comprising:
a first fixture the supports the optical fiber and the beam separator; and
a second fixture that supports the one modulator and the telescope.

18. The optical device of claim 17 wherein one of the first fixture and the second fixture moves with respect to the other of the first fixture and the second fixture.

19. The optical device of claim 18 wherein the phase information is associated with a movement of the one of the first fixture and the second fixture.

20. The optical device of claim 17 wherein the first fixture and the second fixture move with respect to each other.

21. The optical device of claim 1 wherein:
the telescope has a 1:1 magnification.

22. The optical device of claim 1 wherein:
the telescope comprises a first lens component having a focal length F1 and a second lens component having a focal length F2, and the first component is spaced F1+F2 from the second component; and
the beam separator is spaced 2F1+2F2 from an output plane, with the telescope located between the beam separator and the output plane.

23. The optical device of claim 1 wherein:
the telescope comprises a first subsystem and a second subsystem;
wherein the first subsystem comprises a first lens component having a focal length F1 and a second lens component having a focal length F2, and the first component is spaced F1+F2 from the second component; and the second subsystem comprises a third lens component having a focal length F3 and a fourth lens component having a focal length F4, and the third component is spaced F3+F4 from the fourth component; and
the beam separator is spaced 2F1+2F2+2F3+2F4 from an output plane, with the telescope located between the beam separator and the output plane.

24. The optical device of claim 22 wherein the telescope has a negative magnification, the optical device further comprising:
image erecting optics that inverts the image of the telescope.

25. The optical device of claim 24 wherein the erecting optics are selected from one or more of the optics in the group consisting of:
a corner cube, a Porro prism, a Dove prism, a roof prism, a prism, a mirror, and a second telescope.

26. The optical device of claim 22 wherein the one modulator is located between the first lens component and the second lens component.

27. An optical device comprising:
a beam separator that receives an input beam and separates the input beam into two beams;
a pair of modulators, each receiving a respective beam of the two beams; and
a telescope that receives the two beams and provides an image of the two beams to an output plane;
wherein at least one of the beam separator and at least one of the pair of modulators encodes phase information onto the two beams.

28. The optical device of claim 27 wherein the beam separator encodes phase information and at least one of the pair of modulators encodes phase information.

29. The optical device of claim 27 wherein the input beam is an ultraviolet input beam.

30. The optical device of claim 27 wherein the beam separator is a phase mask.

31. The optical device of claim 30 wherein the phase mask forms the two beams by diffracting the input beam into two first order beams.

32. The optical device of claim 31 wherein the device further comprises:
a stop which blocks a zero order diffracted beam.

33. The optical device of claim 27 wherein the beam separator is a beam splitter.

34. The optical device of claim 33 wherein the beam splitter does not encode phase information onto either beam of the two beams.

35. The optical device of claim 27 wherein each of the pair of modulators are each of the type selected from the group consisting of:
electro-optic, mechanically driven, thermo-optic, acousto-optic, and magneto-optic.

36. The optical device of claim 27 wherein each of the pair of modulators are electro-optic modulators.

37. The optical device of claim 36 wherein the electro-optic modulators are Pockels cell modulators.

38. The optical device of claim 36 wherein the pair of modulators are connected to each other such that the phase information to be encoded is distributed between the pair of modulators.

39. The optical device of claim 36 wherein the pair of modulators do not encode phase information onto either beam of the two beams.

40. The optical device of claim 27 wherein the two beams interfere with each other at an output plane to form an interference pattern.

41. The optical device of claim 40 wherein the interference pattern is formed proximate to an optical fiber.

42. The optical device of claim 40 wherein the interference pattern forms a grating in the optical fiber.

43. The optical device of claim 42 wherein the grating is Bragg grating.

44. The optical device of claim 41 further comprising:
a first fixture the supports the optical fiber and the beam separator; and
a second fixture that supports the pair of modulators and the telescope.

45. The optical device of claim 44 wherein one of the first fixture and the second fixture moves with respect to the other of the first fixture and the second fixture.

46. The optical device of claim 45 wherein the phase information is associated with a movement of the one of the first fixture and the second fixture.

47. The optical device of claim 44 wherein the first fixture and the second fixture move with respect to each other.

48. The optical device of claim 27 wherein:
the telescope has a 1:1 magnification.

49. The optical device of claim 27 wherein:
the telescope comprises a first lens component having a focal length F1 and a second lens component having a focal length F2, and the first component is spaced F1+F2 from the second component; and
the beam separator is spaced 2F1+2F2 from an output plane, with the telescope located between the beam separator and the output plane.

50. The optical device of claim 27 wherein:
the telescope comprises a first subsystem and a second subsystem;
wherein the first subsystem comprises a first lens component having a focal length F1 and a second lens component having a focal length F2, and the first component is spaced F1+F2 from the second component; and the second subsystem comprises a third lens component having a focal length F3 and a fourth lens component having a focal length F4, and the third component is spaced F3+F4 from the fourth component; and
the beam separator is spaced 2F1+2F2+2F3+2F4 from an output plane, with the telescope located between the beam separator and the output plane.

51. The optical device of claim 27 wherein the telescope has a negative magnification, the optical device further comprising:
image erecting optics that inverts the image of the telescope.

52. The optical device of claim 51 wherein the erecting optics are selected from one or more of the optics in the group consisting of:
a corner cube, a Porro prism, a Dove prism, a roof prism, a prism, a mirror, and a second telescope.

53. The optical device of claim 49 wherein the pair of modulators is located between the first lens component and the second lens component.

54. An optical device comprising:
a phase mask that receives an input beam and separates the input beam into two beams;
a telescope that receives the two beams and provides an image of the two beams to an output plane; and
wherein the phase mask encodes phase information onto the two beams.

55. The optical device of claim 54 wherein the input beam is an ultraviolet input beam.

56. The optical device of claim 54 wherein the phase mask forms the two beams by diffracting the input beam into two first order beams.

57. The optical device of claim 56 wherein the device further comprises:
a stop which blocks a zero order diffracted beam.

58. The optical device of claim 56 wherein the two beams interfere with each other at an output plane to form an interference pattern.

59. The optical device of claim 58 wherein the interference pattern is formed proximate to an optical fiber.

60. The optical device of claim 58 wherein the interference pattern forms a grating in the optical fiber.

61. The optical device of claim 60 wherein the grating is Bragg grating.

62. The optical device of claim 59 further comprising:
a first fixture the supports the optical fiber and the phase mask; and
a second fixture that supports the telescope.

63. The optical device of claim 62 wherein one of the first fixture and the second fixture moves with respect to the other of the first fixture and the second fixture.

64. The optical device of claim 63 wherein the phase information is associated with a movement of the one of the first fixture and the second fixture.

65. The optical device of claim 62 wherein the first fixture and the second fixture move with respect to each other.

66. The optical device of claim 54 wherein:
the telescope has a 1:1 magnification.

67. The optical device of claim 54 wherein:
the telescope comprises a first lens component having a focal length F1 and a second lens component having a focal length F2, and the first component is spaced F1+F2 from the second component; and
the phase mask is spaced 2F1+2F2 from an output plane, with the telescope located between the phase mask and the output plane.

68. The optical device of claim 54 wherein:
the telescope comprises a first subsystem and a second subsystem;
wherein the first subsystem comprises a first lens component having a focal length F1 and a second lens component having a focal length F2, and the first component is spaced F1+F2 from the second component; and the second subsystem comprises a third lens component having a focal length F3 and a fourth lens component having a focal length F4, and the third component is spaced F3+F4 from the fourth component; and
the phase mask is spaced 2F1+2F2+2F3+2F4 from an output plane, with the telescope located between the phase mask and the output plane.

69. The optical device of claim 54 wherein the telescope has a negative magnification, the optical device further comprising:
image erecting optics that inverts the image of the telescope.

70. The optical device of claim 69 wherein the erecting optics are selected from one or more of the optics in the group consisting of:
a corner cube, a Porro prism, a Dove prism, a roof prism, a prism, a mirror, and a second telescope.

71. An optical device comprising:
means for separating an input beam into two beams;
means for modulating each beam of the two beams;
means for providing an image of the two beams to an output plane; and
wherein at least one of the means for separating and the means for modulating encodes phase information onto the two beams.

72. The optical device of claim 71 wherein both the means for separating and the means for modulating encodes phase information.

73. The optical device of claim 71 wherein the means for separating operates by diffracting the input beam into two first order beams.

74. The optical device of claim 73 wherein the device further comprises:
means for stopping a zero order diffracted beam.

75. The optical device of claim 71 wherein the means for separating does not encode phase information onto either beam of the two beams.

76. The optical device of claim 71 wherein the means for modulating does not encode phase information onto either beam of the two beams.

77. The optical device of claim 71 wherein the two beams interfere with each other at an output plane to form an interference pattern.

78. The optical device of claim 77 wherein the interference pattern is formed proximate to an optical fiber.

79. The optical device of claim 77 wherein the interference pattern forms a grating in the optical fiber.

80. The optical device of claim 79 wherein the grating is Bragg grating.

81. The optical device of claim 77 further comprising:
first means for supporting the optical fiber and the means for separating; and
second means for supporting the means for modulating.

82. The optical device of claim 81 wherein one of the first means for supporting and the second means for supporting moves with respect to the other of the first means for supporting and the second means for supporting.

83. The optical device of claim 82 wherein the phase information is associated with a movement of the one of the first means for supporting and the second means for supporting.

84. The optical device of claim 81 wherein the first means for supporting and the second means for supporting move with respect to each other.

85. A method for operating an optical device comprising:
separating an input beam into two beams; and
modulating each beam of the two beams;
providing an image of the two beams to an output plane; and
encoding phase information onto the two beams via at least one of the steps of separating and step of modulating.

86. The method of claim 85 wherein both the step of separating and the step of modulating are operative during the step of encoding.

87. The method of claim 85 wherein the step of separating comprises:
diffracting the input beam into two first order beams.

88. The method of claim 87 further comprising:
stopping a zero order diffracted beam.

89. The method of claim 85 wherein the step of separating is not operative during the step of encoding.

90. The method of claim 85 wherein the step of modulating is not operative during the step of encoding.

91. The method of claim 85 further comprising:
forming an interference pattern by interfering the two beams interfere with each other at an output plane.

92. The method of claim 91 wherein the interference pattern is formed proximate to an optical fiber.

93. The method of claim 91 wherein the interference pattern forms a grating in the optical fiber.

94. The method of claim 93 wherein the grating is Bragg grating.
